(19) United States
(12) Patent Application Publication
(10) Pub. No.: US 2019/0305313 A1
(43) Pub. Date: Oct. 3, 2019

(54) POSITIVE ELECTRODE, LITHIUM AIR BATTERY INCLUDING POSITIVE ELECTRODE, AND METHOD OF PREPARING POSITIVE ELECTRODE

(71) Applicants: Samsung Electronics Co., Ltd., Suwon-si (KR); Seoul National University R&DB Foundation, Seoul (KR)

(72) Inventors: Hyunjin KIM, Seoul (KR); Chongrae PARK, Seoul (KR); Hongsoo CHOI, Seoul (KR); Hyukjae KWON, Suwon-si (KR); Minhoo BYEON, Seoul (KR); Dongjoon LEE, Suwon-si (KR); Dongmin IM, Seoul (KR); Youngshik CHO, Seoul (KR); Yeonsu JUNG, Seoul (KR)

(21) Appl. No.: 16/177,496

(22) Filed: Nov. 1, 2018

(30) Foreign Application Priority Data
Mar. 30, 2018 (KR) 10-2018-0037758

(51) Int. Cl. H01M 4/60; H01M 4/137; H01M 10/0525; H01M 4/1399; H01M 12/06

(52) U.S. Cl. CPC H01M 4/608; H01M 4/137; H01M 2004/028; H01M 4/1399; H01M 12/06; H01M 10/0525

(57) ABSTRACT

A positive electrode includes: a carbonaceous core; a coating layer including an electrolyte-philic organic compound on the carbonaceous core; a lithium salt; and an electrolyte, wherein the organic compound includes an imide functional group.

### CROSS-REFERENCE TO RELATED APPLICATION

This application claims priority to and the benefit of Korean Patent Application No. 10-2018-0037758, filed on Mar. 30, 2018, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a positive electrode, a lithium air battery including the positive electrode, and a method of preparing the positive electrode.

### 2. Description of the Related Art

A metal air battery, which is a type of electrochemical cell, includes a negative electrode capable of intercalating and deintercalating metal ions, a positive electrode for oxidizing/reducing oxygen in the air, and a metal ion conductive medium between the positive electrode and the negative electrode.

A metal air battery employs a metal as a negative electrode and the positive active material can be air and thus the positive active material does not need to be stored in the battery, thus enabling the battery to have a large capacity. The theoretical energy density per unit weight of a metal air battery may be very high, about 3,500 Watt-hour per kilogram (Wh/kg) in the case of lithium. Nonetheless, there remains a need for an improved metal-air battery material.

### SUMMARY

Provided is a positive electrode including a carbonaceous material having a modified surface.

Provided is a lithium air battery including the positive electrode.

Provided is a method of preparing the positive electrode.

Additional aspects will be set forth in part in the description which follows and, in part, will be apparent from the description, or may be learned by practice of the presented embodiments.

According to an aspect of an embodiment, a positive electrode includes: a carbonaceous core; a coating layer including an electrolyte-philic organic compound on the carbonaceous core; a lithium salt; and an electrolyte, wherein the electrolyte-philic organic compound includes an imide functional group.

According to an aspect of an embodiment, a lithium air battery includes: the positive electrode; a negative electrode capable of intercalating and deintercalating lithium ions; and a separator between the positive electrode and the negative electrode.

According to an aspect of an embodiment, a method of preparing a positive electrode includes: providing an electrolyte-philic organic compound including an imide functional group; contacting the electrolyte-philic organic compound and a carbonaceous core to form a mixture; and heat-treating the mixture at a temperature in a range of from about 100° C. to about 250° C. to prepare the positive electrode, the positive electrode including the carbonaceous core and a coating layer including the electrolyte-philic organic compound on the carbonaceous core.

### BRIEF DESCRIPTION OF THE DRAWINGS

These and/or other aspects will become apparent and more readily appreciated from the following description of the embodiments, taken in conjunction with the accompanying drawings in which:

FIG. 1 is a transmission electron microscope (“TEM”) image of a carbon nanotube (“CNT”) prepared in Preparation Example 10 on which a coating layer of an organic compound including an imide group is formed;

FIG. 2 is a TEM image of a pure CNT without a coating layer prepared in Comparative Preparation Example 1;

FIG. 3 is a graph of relative weight (percent, %) versus temperature (° C.) illustrating the result of thermogravimetric analysis (“TGA”) performed on the CNT prepared in Preparation Example 10 on which a coating layer of an organic compound including an imide group is formed and the pure CNT without a coating layer prepared in Comparative Preparation Example 1;

FIG. 4 is a graph of intensity (arbitrary units) versus binding energy (electron volts, eV) illustrating the result of X-ray photoelectron spectroscopy (“XPS”) analysis of the CNT prepared in Preparation Example 10 on which a coating layer of an organic compound including an imide group is formed and the pure CNT without a coating layer prepared in Comparative Preparation Example 1;

FIG. 5A illustrates a contact angle between an electrolyte and the CNT on which a coating layer of an organic compound including an imide group prepared in Preparation Example 10 is formed;

FIG. 5B illustrates a contact angle between an electrolyte and the CNT on which a coating layer of an organic compound including an imide group prepared in Preparation Example 16 is formed;

FIG. 5C illustrates a contact angle between an electrolyte and the CNT of Comparative Preparation Example 1;

FIG. 6A is a graph of voltage (volts, V vs. Li/Li) versus capacity (milliampere-hours per gram, mAh·g⁻¹) illustrating charge/discharge characteristics of lithium air batteries of Example 10 and Comparative Example 4;

FIG. 6B is a graph of voltage (V vs. Li/Li) versus capacity (mAh·g⁻¹) illustrating charge/discharge characteristics of lithium air batteries of Example 16 and Comparative Example 4;

FIG. 7A is a graph of voltage (V vs. Li/Li) versus capacity (mAh·g⁻¹) illustrating charge/discharge characteristics of the lithium air batteries of Example 10 and Comparative Example 4;

FIG. 7B is a graph of voltage (V vs. Li/Li) versus capacity (mAh·g⁻¹) illustrating charge/discharge characteristics of lithium air batteries of Comparative Example 5 and Comparative Example 6;

FIG. 8A is a graph of capacity (mAh·g⁻¹) versus the number of cycles illustrating charge/discharge cycles of the lithium air batteries of Example 10 and Comparative Example 4;

FIG. 8B is a graph of capacity (mAh·g⁻¹) versus the number of cycles illustrating charge/discharge cycles of the lithium air batteries of Example 16 and Comparative Example 4;

FIG. 9A is a scanning electron microscope (“SEM”) image of the CNT in the lithium air battery of Example 10 after 27 cycles of discharging;

FIG. 9B is a SEM image of the CNT in the lithium air battery of Example 10 after 27 cycles of charging;

FIG. 9C is a SEM image of the CNT in the lithium air battery of Comparative Example 4 after 27 cycles of discharging;

FIG. 9D is a SEM image of the CNT in the lithium air battery of Comparative Example 4 after 27 cycles of charging; and

FIG. 10 illustrates a schematic view of an embodiment of a lithium air battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” and “upper,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Aliphatic” means a saturated or unsaturated linear or branched hydrocarbon group. An aliphatic group may be an alkyl, alkenyl, or alkynyl group, for example.

“Alkoxy” means an alkyl group that is linked via an oxygen (i.e., alkyl-O—), for example methoxy, ethoxy, and sec-butyloxy groups.

“Alkyl” means a straight or branched chain, saturated, monovalent hydrocarbon group (e.g., methyl or hexyl).

“Alkylene” means a straight or branched chain, saturated, divalent aliphatic hydrocarbon group, (e.g., methylene (—CH₂—) or, propylene (—(CH₂)₃—)).

“Alkynyl” means a straight or branched chain, monovalent hydrocarbon group having at least one carbon-carbon triple bond (e.g., ethynyl).

“Arene” means a hydrocarbon having an aromatic ring, and includes monocyclic and polycyclic hydrocarbons wherein the additional ring(s) of the polycyclic hydrocarbon may be aromatic or nonaromatic. Specific arenes include benzene, naphthalene, toluene, and xylene.

“Aryl” means a monovalent group formed by the removal of one hydrogen atom from one or more rings of an arene (e.g., phenyl or naphthyl).

“Arylalkyl” means a substituted or unsubstituted aryl group covalently linked to an alkyl group that is linked to a compound (e.g., a benzyl is a C7 arylalkyl group).

“Cycloalkenyl” means a monovalent group having one or more rings and one or more carbon-carbon double bond in the ring, wherein all ring members are carbon (e.g., cyclopentyl and cyclohexyl).

“Cycloalkyl” means a monovalent group having one or more saturated rings in which all ring members are carbon (e.g., cyclopentyl and cyclohexyl).

“Cycloalkynyl” means a stable aliphatic monocyclic or polycyclic group having at least one carbon-carbon triple bond, wherein all ring members are carbon (e.g., cyclohexynyl).

“Ester” refers to a group of the formula —O(C═O)R^{x} or a group of the formula —(C═O)OR^{x} wherein R^{x} is C1 to C28 aromatic organic group or aliphatic organic group. An ester group includes a C2 to C30 ester group, and specifically a C2 to C18 ester group.

The prefix “hetero” means that the compound or group includes at least one a heteroatom (e.g., 1, 2, or 3 heteroatom(s)), wherein the heteroatom(s) is each independently N, O, S, Si, or P.

“Heteroalkyl” is an alkyl group that comprises at least one heteroatom covalently bonded to one or more carbon atoms of the alkyl group. Each heteroatom is independently chosen from nitrogen (N), oxygen (O), sulfur (S), and or phosphorus (P).

“Heteroaryl” means a monovalent carbocyclic ring group that includes one or more aromatic rings, in which at least one ring member (e.g., one, two or three ring members) is a heteroatom. In a C3 to C30 heteroaryl, the total number of ring carbon atoms ranges from 3 to 30, with remaining ring atoms being heteroatoms. Multiple rings, if present, may be pendent, spiro or fused. The heteroatom(s) are generally independently nitrogen (N), oxygen (O), P (phosphorus), or sulfur (S).

“Heteroarylalkyl” means a heteroaryl group linked via an alkylene moiety. The specified number of carbon atoms (e.g., C3 to C30) means the total number of carbon atoms present in both the aryl and the alkylene moieties, with remaining ring atoms being heteroatoms.

“Imide” means a group having two carbonyl groups bound to nitrogen, e.g., succinimide.

“Ketone” refers to a C2 to C30 ketone group, and specifically a C2 to C18 ketone group. Ketone groups have the indicated number of carbon atoms, with the carbon of the keto group being included in the numbered carbon atoms. For example a C2 ketone group is an acetyl group having the formula CH₃(C═O)—.

“Oxyalkyl” means an alkyl group to which at least one oxygen atom is covalently attached (e.g., via a single bond, forming a hydroxyalkyl or ether group, or double bond, forming a ketone or aldehyde moiety).

“Substituted” means a compound or radical substituted with at least one (e.g., 1, 2, 3, 4, 5, 6 or more) substituent, and the substituents are independently a halogen (e.g., F—, Cl—, Br—, I—), a hydroxyl, an alkoxy, a nitro, a cyano, an amino, an azido, an amidino, a hydrazino, a hydrazono, a carbonyl, a carbamyl, a thiol, a C1 to C6 alkoxycarbonyl, an ester, a carboxyl, or a salt thereof, sulfonic acid or a salt thereof, phosphoric acid or a salt thereof, a C₁ to C₂₀ alkyl, a C₂ to C₁₆ alkynyl, a C₆ to C₂₀ aryl, a C₇ to C₁₃ arylalkyl, a C₁ to C₄ oxyalkyl, a C₁ to C₂₀ heteroalkyl, a C₃ to C₂₀ heteroaryl (i.e., a group that comprises at least one aromatic ring, wherein at least one ring member is other than carbon), a C₃ to C₂₀ heteroarylalkyl, a C₃ to C₂₀ cycloalkyl, a C₃ to C₁₅ cycloalkenyl, a C₆ to C₁₅ cycloalkynyl, a C₅ to C₁₅ heterocycloalkyl, or a combination including at least one of the foregoing, instead of hydrogen, provided that the substituted atom's normal valence is not exceeded.

A carbonaceous material, that may be used in a positive electrode, e.g., air electrode, of a metal-air battery, may have a large specific surface area and a nonpolar surface. An electrolyte, through which lithium ions migrate to the positive electrode may comprise a polar polymer or an ionic liquid. The polarity of a surface of the carbonaceous material may differ from that of the electrolyte, and thus the interfacial tension between the carbonaceous material and the electrolyte may be high. While not wanting to be bound by theory, it is understood that because of the difference in the polarity of the surface of the carbonaceous material and that of the electrolyte impregnation of the carbonaceous material in the electrolyte may be insufficient, or the carbonaceous material may not be uniformly dispersed in the electrolyte. Insufficient electrolyte impregnation in the carbonaceous material is understood to result in incomplete utilization of the large specific surface area of the carbonaceous material. Desired is improved contact between a surface of a carbonaceous material and an electrolyte.

Hereinafter, according to example embodiments, a positive electrode, a lithium air battery including the positive electrode, and a method of preparing the positive electrode will be described in further detail.

A positive electrode, according to an example embodiment, may include a carbonaceous core; a coating layer comprising an electrolyte-philic organic compound on the carbonaceous core; a lithium salt; and an electrolyte, wherein the electrolyte-philic organic compound includes an imide-based functional group. The positive electrode is configured to use oxygen as a positive active material.

A lithium air battery may have a reaction mechanism as shown in Reaction Scheme 1:

4Li+O₂↔2Li₂O E°=2.91 V

2Li+O₂↔Li₂O₂ E°=3.10 V Reaction Scheme 1

Upon discharging, lithium from a negative electrode may react with oxygen from a positive electrode, thereby forming lithium oxide and reducing oxygen. Upon charging, lithium oxide may be reduced, and oxygen may be oxidized and generated. Upon discharging, Li₂O₂ may be deposited through a pore of the positive electrode, and capacity of the lithium air battery may increase, as an area of an electrolyte in contact with the positive electrode increases.

In the positive electrode, a surface of a pure carbonaceous material may be nonpolar. The electrolyte, through which lithium ions migrate to the positive electrode, may be a polar polymer or an ionic liquid. Thus, the polarity of a surface of the carbonaceous material differs from that of the electrolyte, which may result in insufficient impregnation of the carbonaceous material in the electrolyte.

In addition, a solubility parameter (δ) of the pure carbonaceous material may be about 19, which is greatly different from a solubility parameter (δ) of a polar polymer or an ionic liquid used as the electrolyte, which may be about 26. Thus, it may be difficult for the carbonaceous material to be sufficiently impregnated in the electrolyte. Accordingly, the carbonaceous material may not be uniformly dispersed in the electrolyte, and it may be difficult to sufficiently utilize the large specific surface area of the carbonaceous material.

A coating layer of an organic compound including an imide group may be polar, and has a solubility parameter (δ) of about 23, which may be similar with that of the electrolyte. Thus, the coating layer of an organic compound including an imide group may be more effectively mixed with the electrolyte, and accordingly, when a carbonaceous core surface is coated with the organic compound including an imide group, the carbonaceous material may be more effectively impregnated in the electrolyte.

As the positive electrode includes a coating layer of the electrolyte-philic organic compound including an imide-based functional group on the carbonaceous core, an effective area of the carbonaceous core in contact with the electrolyte may increase. Accordingly, the positive electrode including the carbonaceous core may provide improved lithium ion conductivity. Therefore, a lithium air battery including the positive electrode may have increased specific capacity and improved lifespan characteristics.

A content of the carbonaceous core may be about 50 weight percent (wt %) to about 99 wt %, about 60 wt % to about 95 wt %, or about 70 wt % to about 85 wt %, based on a total weight of the positive electrode.

Regarding the electrolyte-philic organic compound, the term “electrolyte-philic” refers to that the organic compound has greater affinity to an electrolyte than to a surface of a pure carbonaceous material, i.e., the organic compound has a small interfacial energy with the electrolyte, or the organic compound has a small interfacial tension with the electrolyte. That is, the electrolyte-philicity of the carbonaceous core may be increased by using a surface modifier for increasing affinity of a surface of a hydrophobic carbonaceous material to an electrolyte.

The imide-based functional group may be a functional group including an imide group (—CO—NR—CO—). The imide-based functional group may be polar, and has a solubility parameter (δ) of about 23, which is similar with that of an electrolyte, and thus may be easily mixed with the electrolyte. For example, the imide-based functional group may be a substituted or unsubstituted maleimide group, a substituted or unsubstituted succinimide group, a substituted or unsubstituted phthalimide group, or a substituted or unsubstituted glutarimide group, but embodiments are not limited thereto. Any suitable imide-based functional group, which may effectively impregnate a carbonaceous core surface in an electrolyte, may be used as long as the imide-based functional group is electrochemically stable within a driving voltage range of a lithium air battery.

At least one substituent of the substituted maleimide group, the substituted succinimide group, the substituted phthalimide group, and the substituted glutarimide group may be deuterium, a substituted or unsubstituted C₁-C₃₀ alkyl group, a substituted or unsubstituted C₃-C₃₀ cycloalkyl group, or a substituted or unsubstituted C₆-C₃₀ aryl group, and

at least one substituent of the substituted C₁-C₃₀ alkyl group, the substituted C₃-C₃₀ cycloalkyl group, and the substituted C₆-C₃₀ aryl group may be: deuterium, —F, —Cl, —Br, —I, a hydroxyl group, a C₁-C₃₀ alkyl group, a C₃-C₃₀ cycloalkyl group, or a C₆-C₃₀ aryl group; or

a C₁-C₃₀ alkyl group, a C₃-C₃₀ cycloalkyl group, and a C₆-C₃₀ aryl group, each substituted with deuterium, —F, —Cl, —Br, —I, a hydroxyl group, a C₁-C₆₀ alkyl group, a C₃-C₃₀ cycloalkyl group, a C₆-C₃₀ aryl group, or a combination thereof.

In addition, the imide-based functional group may be electrochemically stable in a voltage range of about 1.5 volts (V) to about 4.5 V vs. lithium. Thus, the imide-based functional group may effectively impregnate the carbonaceous core surface in the electrolyte within a driving voltage range of a lithium air battery. For example, the imide-based functional group may be electrochemically stable in a voltage range of about 1.7 V to about 4.2 V vs. lithium. For example, within the foregoing voltage range, a carboxyl group may be electrochemically unstable and thus may participate in an electrode reaction. Consequently, over charging and discharging, electrolyte-philicity of a coating layer may decrease.

The organic compound including an imide-based functional group may be represented by Formula 1, but embodiments are not limited thereto:

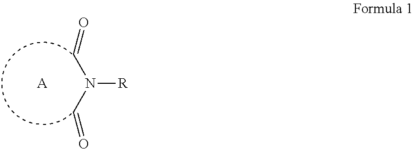

wherein, in Formula 1,

ring A may be a C₂-C₃₀ heterocyclic group containing an imide group,

R may be hydrogen, deuterium, a substituted or unsubstituted C₁-C₃₀ alkyl group, a substituted or unsubstituted C₃-C₃₀ cycloalkyl group, or a substituted or unsubstituted C₆-C₃₀ aryl group,

at least one substituent of the substituted C₁-C₃₀ alkyl group, the substituted C₃-C₃₀ cycloalkyl group, and the substituted C₆-C₃₀ aryl group may be:
deuterium, —F, —Cl, —Br, —I, a hydroxyl group, a C₁-C₃₀ alkyl group, a C₃-C₃₀ cycloalkyl group, or a C₆-C₃₀ aryl group; or
a C₁-C₃₀ alkyl group, a C₃-C₃₀ cycloalkyl group, and a C₆-C₃₀ aryl group, each substituted with deuterium, —F, —Cl, —Br, —I, a hydroxyl group, a C₁-C₆₀ alkyl group, a C₃-C₃₀ cycloalkyl group, a C₆-C₃₀ aryl group, or a combination thereof.

In some embodiments, ring A may be a C₂-C₃₀ heterocycloalkane ring, a C₂-C₃₀ heterocycloalkene ring, a C₂-C₃₀ heterocycloalkyne ring, or a C₂-C₃₀ heteroaryl ring, each containing an imide group, but embodiments are not limited thereto.

In some embodiments, R may be a C₁-C₃₀ alkyl group, a C₃-C₃₀ cycloalkyl group, or a C₆-C₃₀ aryl group, each substituted with at least one —CF₃, but embodiments are not limited thereto.

The organic compound including an imide-based functional group may include a multiple bond or a conjugated bond. For example, the multiple bond may be a double bond or a triple bond. For example, the conjugated bond may be a bond including a double bond-a single bond-a double bond. Formation of a coating layer of an electrolyte-philic organic compound on a carbonaceous core may be caused by hydrophobic interaction or caused by interaction by overlapping of π-electron cloud derived from a conjugated system on the organic compound having a multiple bond or a conjugated bond with a carbonaceous core. For example, a bond between the organic compound and the carbonaceous core may be a thermoreversible crosslink bond by Diels-alder reaction.

The organic compound represented by Formula 1 may be represented by one of Compounds 1-1 to 1-9, or a combination thereof, but embodiments are not limited thereto:

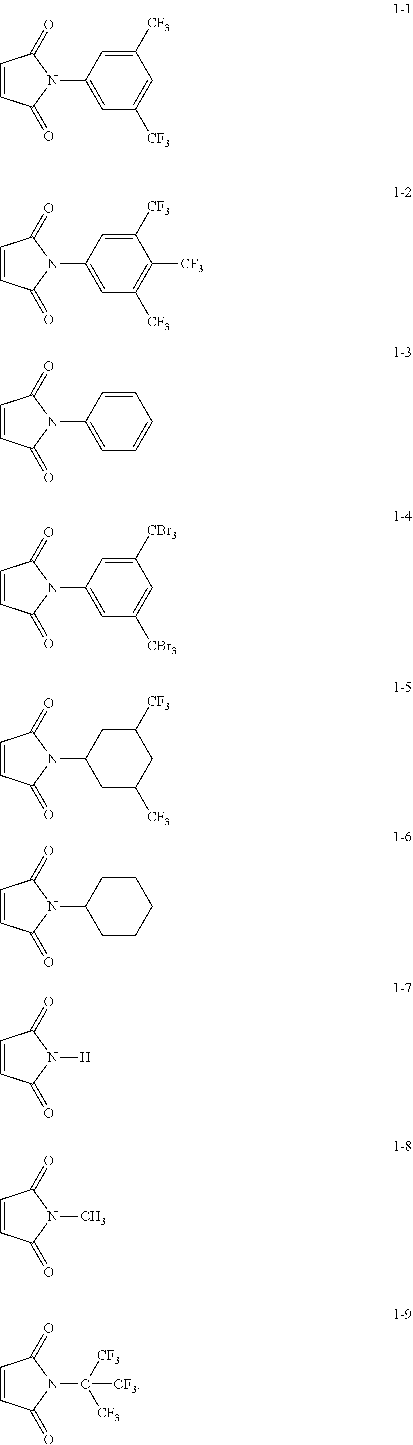

The term “coating layer” in the coating layer of the organic compound refers to a layer formed by formation of a physical bond or chemical bond of an electrolyte-philic organic compound on a part of or on the whole surface of a carbonaceous core. When the surface of a carbonaceous core is coated with an electrolyte-philic organic compound, the surface of the carbonaceous core may be modified.

In a positive electrode, the coating layer of an electrolyte-philic organic compound may form a composite with the carbonaceous core. For example, a coating layer of an organic compound may not be simply mixed with a core; rather, the coating layer may be chemically or mechanochemically connected to the core. Accordingly, the composite carbon material including the core and the coating layer of an organic compound may differ from a relatively simple mixture of a core and a coating layer of an organic compound.

In the positive electrode, a thickness of the coating layer of an electrolyte-philic organic compound may be in a range of about 1 nanometers (nm) to about 20 nm. In some embodiments, in the positive electrode, a thickness of the coating layer of an electrolyte-philic organic compound may be in a range of about 1 nm to about 15 nm. In some embodiments, in the positive electrode, a thickness of the coating layer of an electrolyte-philic organic compound may be in a range of about 3 nm to about 10 nm. In some embodiments, in the positive electrode, a thickness of the coating layer of an electrolyte-philic organic compound may be in a range of about 5 nm to about 8 nm. When a thickness of the coating layer is less than 1 nm, an effective area of the electrolyte-philic organic compound coated on the carbonaceous core in contact with the electrolyte may insignificantly increase. When a thickness of the coating layer is greater than 20 nm, a conductivity of the carbonaceous core may decrease, which may result in an increase in internal resistance of a lithium air battery employing a positive electrode including the coating layer, consequently deteriorating charge/discharge characteristics of the lithium air battery.

In addition, in the positive electrode, a content of the coating layer of the electrolyte-philic organic compound may be in a range of about 1 percent by weight (wt %) to about 20 wt %, based on a total weight of the carbonaceous core. In some embodiments, a content of the coating layer of the electrolyte-philic organic compound may be in a range of about 5 wt % to about 20 wt %, based on a total weight of the carbonaceous core. In some embodiments, a content of the coating layer of the electrolyte-philic organic compound may be in a range of about 7 wt % to about 18 wt %, based on a total weight of the carbonaceous core. In some embodiments, a content of the coating layer of the electrolyte-philic organic compound may be in a range of about 10 wt % to about 15 wt %, based on a total weight of the carbonaceous core. When a content of the coating layer of the electrolyte-philic organic compound is less than 1 wt %, an effective area of the electrolyte-philic organic compound coated on the carbonaceous core in contact with the electrolyte may insignificantly increase. When a content of the coating layer of the electrolyte-philic organic compound is greater than 20 wt %, a conductivity of the carbonaceous core may decrease, which may result in an increase in internal resistance of a lithium air battery employing a positive electrode including the coating layer, consequently deteriorating charge/discharge characteristics of the lithium air battery.

The coating layer may be coated continuously or in an island form on the carbonaceous core. The coating form of the coating layer is not particularly limited thereto.

The carbonaceous core in the positive electrode may have a spherical shape, a rod shape, a planar shape, a tube shape, or a combination thereof, but the shape of the carbonaceous core is not particularly limited thereto. Any suitable shape that may be used as a core may be used. In some embodiments, the carbonaceous core may be a porous material having pores and a large specific surface area.

The carbonaceous core in the positive electrode may be porous. In some embodiments, the carbonaceous core may be mesoporous. In some embodiments, regarding the carbonaceous core, the various shapes of the carbonaceous core may be partially or wholly porous.

The carbonaceous core may include carbon black, Ketjen black, acetylene black, natural graphite, artificial graphite, expanded graphite, graphene, graphene oxide, fullerene soot, mesophase carbon microbeads (“MCMBs”), carbon nanotubes (“CNTs”), carbon nanofibers, carbon nanobelts, soft carbon, hard carbon, pitch carbide, mesophase pitch carbide, sintered coke, or a combination thereof, but embodiments are not limited thereto. Any suitable carbonaceous material available in the art may be used.

The electrolyte in the positive electrode may include an ion conductive polymer, an ionic liquid, an organic liquid electrolyte, or a combination thereof, but embodiments are not limited thereto. Any suitable electrolyte that may be used in a lithium air battery may be used.

In some embodiments, as described above, the electrolyte may be an aqueous electrolyte or a nonaqueous electrolyte including an organic solvent.

The ion conductive polymer used as an electrolyte in the positive electrode may include polyethylene oxide (“PEO”), polyvinyl alcohol (“PVA”), polyvinyl pyrrolidone (“PVP”), polysulfone, or a combination thereof, but embodiments are not limited thereto. Any suitable ion conductive polymer used as an electrolyte having lithium ion conductivity in a lithium air battery available in the art may be used.

The ionic liquid used as an electrolyte in the positive electrode may include 11-ethyl-3-methylimidazolium bis-(trifluoromethylsulfonyl)imide (“EMI-TFSI)”, diethylmethylammonium trifluoromethanesulfonate (“[dema][TfO]”), dimethylpropylammonium trifluoromethanesulfonate (“[dmpa][TfO]”), diethylmethylammonium trifluoromethanesulfonylimide (“[dema][TFSI]”), methylpropylpiperidinium trifluoromethanesulfonylimide (“[mpp][TFSI]”), or a combination thereof, but embodiments are not limited thereto. Any suitable ionic liquid used as an electrolyte having lithium ion conductivity in a lithium air battery available in the art may be used.

Examples of the ionic liquid include linear or branched, substituted compounds containing anions such as ammonium, imidazolium, pyrrolidinium, and piperidinium, and anions such as PF₆⁻, BF₄⁻, CF₃SO₃⁻, (CF₃SO₂)₂N⁻, (C₂F₅SO₂)₂N⁻, (C₂F₅SO₂)₂N⁻, and (CN)₂N⁻.

The electrolyte in the positive electrode may be solid. As the electrolyte in the positive electrode is solid, the structure of a lithium air battery may be relatively simple, and the lithium air battery may not encounter problems such as leakage, thus improving safety thereof.

When the electrolyte in the positive electrode is solid, the electrolyte may be a polymer electrolyte. When the electrolyte is a polymer electrolyte including an ion conductive polymer, the electrolyte may be in solid state at room temperature and have lithium ion conductivity.

The electrolyte in the positive electrode may be a solvent-free electrolyte. For example, the electrolyte in the positive electrode may not contain a solvent and may be a solid polymer electrolyte including an ion conductive polymer. When the electrolyte in the positive electrode does not contain a solvent, problems such as a side reaction caused by a solvent or leakage may not occur.

The solvent-free electrolyte differs from a polymer gel electrolyte, which is a solid polymer containing a small amount of a solvent. The polymer gel electrolyte, for example, an ion conductive polymer including a small amount of a solvent, may have further improved ion conductivity.

In some embodiments, the electrolyte in the positive electrode may be a solvent-containing electrolyte. The solvent-containing electrolyte may be an aqueous electrolyte containing an aqueous solvent or a nonaqueous electrolyte containing an organic-based solvent.

The nonaqueous (or organic-based) electrolyte may include an aprotic solvent. The aprotic solvent may be, for example, a carbonate-based solvent, an ester-based solvent, an ether-based solvent, or a ketone-based solvent. Examples of the carbonate-based solvent include dimethyl carbonate (“DMC”), diethyl carbonate (“DEC”), ethylmethyl carbonate (“EMC”), dipropyl carbonate (“DPC”), methylpropyl carbonate (“MPC”), ethylpropyl carbonate (“EPC”) ethylene carbonate (“EC”), propylene carbonate (“PC”), butylene carbonate (“BC”), and tetraethylene glycol dimethyl ether (“TEGDME”). Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, and caprolactone. Examples of the ether-based solvent include dibutyl ether, tetraglyme, diglyme, dimethoxyethane, 2-methyl tetrahydrofuran, and tetrahydrofuran. An example of the ketone-based solvent may be cyclohexanone. However, embodiments are not limited thereto; any suitable aprotic solvent available in the art may be used.

Non-limiting examples of the aprotic solvent are nitriles (such as compounds of the formula R—CN, wherein R is a C₂-C₂₀ linear, branched, or cyclic hydrocarbon-based moiety that may include a double-bonded aromatic ring or an ether bond), amides (such as dimethylformamide), dioxolanes (such as 1,3-dioxolane), and sulfolanes.

The aprotic solvent may be used alone or in a mixture of at least one of the aprotic solvents. When the mixture of at least one of the aprotic solvents is used, a mixing ratio thereof may be appropriately selected depending on a performance of a battery, which may be understood by one of ordinary skill in the art.

The electrolyte may include a salt of an alkali metal and/or an alkaline earth metal. The salt of an alkali metal and/or an alkaline earth metal may be dissolved in an organic solvent, and may act as a source of alkali metal ions and/or alkaline earth metal ions in a battery. For example, the salt may promote migration of alkali metal ions and/or alkaline earth metal ions between an air electrode and a negative electrode.

For example, a cation of the salt of an alkali metal and/or an alkaline earth metal may be a lithium ion, a sodium ion, a magnesium ion, a potassium ion, a calcium ion, a rubidium ion, a strontium ion, a cesium ion, or a barium ion.

An anion of the salt in the electrolyte may include PF₆⁻, BF₄⁻, SbF₆⁻, AsF₆⁻, C₄F₉SO₃⁻, ClO₄⁻, AlO₂⁻, AlCl₄⁻, CₓF₂ₓ₊₁SO₃⁻ (wherein x is a natural number), (CₓF₂ₓ₊₁SO₂)(C_{y}F_{2y+1}SO₂)N⁻ (wherein x and y are each a natural number), a halide, or a combination thereof.

For example, the salt of an alkali metal and/or an alkaline earth metal may be LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (wherein x and y are each in a range of 1 to 30), LiF, LiBr, LiCl, LiI and LiB(C₂O₄)₂ (lithium bis(oxalato) borate (“LiBOB”) lithium bis(trifluoromethanesulfonyl)imide (“LiTFSI”), LiNO₃, or a combination thereof. However, embodiments are not limited thereto; any suitable salt of an alkali metal and/or an alkaline earth metal solvent available in the art may be used.

An amount of the salt of an alkali metal and/or an alkaline earth metal in the electrolyte may be in a range of about 100 millimolar (mM) to about 10 molar (M). In some embodiments, an amount of the salt may be in a range of about 500 mM to about 2M.

When a polymer electrolyte is used, a molar ratio of a monomer in a polymer to a lithium ion may be in a range of about 40:1 to about 5:1.

For example, when polyethylene oxide is used as a polymer electrolyte, a molar ratio of an ethylene oxide moiety in polyethylene oxide to a lithium ion may be 10:1 or 16:1. However, the amount is not necessarily limited to these ranges. The salt may be used in an amount that may enable the electrolyte to effectively transfer lithium ions and/or electrons in a charge/discharge process.

A weight ratio of a weight of the electrolyte to a total weight of the carbonaceous core and the coating layer of the electrolyte-philic organic compound may be in a range of about 1:1 to about 5:1. For example, a weight ratio of a weight of the electrolyte to a total weight of the carbonaceous core and the coating layer of the electrolyte-philic organic compound may be in a range of about 2:1 to about 4:1. For example, a weight ratio of a weight of the electrolyte to a total weight of the carbonaceous core and the coating layer of the electrolyte-philic organic compound may be in a range of about 2.5:1 to about 3:1. When the weight ratio of a weight of the electrolyte to a total weight of the carbonaceous core and the coating layer of the electrolyte-philic organic compound is within this range, a lithium air battery employing the positive electrode may have improved electrolyte-retaining ability and excellent discharge capacity even with a small amount of the electrolyte.

According to an example embodiment, a lithium air battery may include the foregoing positive electrode; a negative electrode capable of intercalating and deintercalating lithium; and a separator between the positive electrode and the negative electrode.

In the lithium air battery, a material for the negative electrode capable of intercalating and deintercalating lithium may be Li metal, an Li metal-based alloy, or a material capable of intercalating and deintercalating lithium, but embodiments are not limited thereto. However, for a negative electrode, any suitable material available in the art that is capable of intercalating and deintercalating lithium may be used. The negative electrode determines the capacity of the lithium air battery and thus the negative electrode may be, for example, lithium metal. For example, the lithium metal-based alloy may be an alloy of lithium with aluminum, tin, magnesium, indium, calcium, titanium, or vanadium.

The separator is not limited as long as it may withstand the use range of the lithium air battery. Examples of the separator include a polymeric nonwoven fabric such as a nonwoven fabric of a polypropylene material or a nonwoven fabric of a polyphenylene sulfide material, and a porous film of an olefin resin such as polyethylene or polypropylene. It is also possible to use two or more thereof in combination.

Also, a lithium ion conductive solid electrolyte membrane may be additionally disposed on a surface of the positive electrode or the negative electrode. For example, the lithium ion conductive solid electrolyte membrane may serve as a protective film to prevent impurities such as water and oxygen contained in the aqueous electrolyte from directly reacting with lithium contained in the negative electrode. Examples of the lithium ion conductive solid electrolyte membrane include lithium ion conductive glass, lithium ion conductive crystal (ceramic or glass-ceramic), or an inorganic material including a mixture thereof, but embodiments are not limited thereto. Any suitable solid electrolyte available in the art, which is lithium ion conductive and capable of protecting a positive electrode or a negative electrode, may be used. In terms of chemical stability, the lithium ion conductive solid electrolyte membrane may be formed of an oxide.

The lithium ion conductive crystal may be Li_{1+x+y}(Al, Ga)ₓ(Ti, Ge)₂₋ₓSi_{y}P_{3-y}O₁₂ (wherein 0≤x≤1 and 0≤y≤1, for example, 0≤x≤0.4 and 0<y≤0.6, or 0.1≤x≤0.3 and 0.1<y≤0.4). Examples of the lithium ion conductive glass-ceramic include lithium-aluminum-germanium-phosphate (“LAGP”), lithium-aluminum-titanium-phosphate (LATP), lithium-aluminum-titanium-silicon-phosphate (“LATSP”), and the like.

In some embodiments, the lithium ion conductive solid electrolyte membrane may further include a polymer solid electrolyte, in addition to the glass-ceramic. The polymer solid electrolyte may be polyethylene oxide doped with a lithium salt. Examples of the lithium salt include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and the like.

In some embodiments, the lithium ion conductive solid electrolyte membrane may further include an inorganic solid electrolyte, in addition to the glass-ceramic. Examples of the inorganic solid electrolyte include Cu₃N, Li₃N, LiPON, and the like.

Upon charging and discharging of the lithium air battery including the positive electrode, the number of cycles in which a discharge capacity of 500 milliampere-hours per gram (mAh/g) or larger at a cut-off voltage of 2.0 volts (V) vs. lithium metal is maintained may be 20 times or more. For example, upon charging and discharging of the lithium air battery including the positive electrode, the number of cycles in which a discharge capacity of 500 mAh/g or larger at a cut-off voltage of 2.0 V vs. lithium metal is maintained may be 25 times or more. For example, upon charging and discharging of the lithium air battery including the positive electrode, the number of cycles in which a discharge capacity of 500 mAh/g or larger at a cut-off voltage of 2.0 V vs. lithium metal is maintained may be 30 times or more. When the positive electrode includes a carbonaceous core on which the coating layer of the electrolyte-philic organic compound including an imide-based functional group is formed, deterioration of the lithium air battery may be suppressed, thereby significantly improving lifespan characteristics thereof.

The lithium air battery may be, for example, manufactured as follows.

First, the positive electrode; a negative electrode capable of intercalating and deintercalating lithium; and a separator may be prepared.

Next, the negative electrode may be mounted on one side of the case, a separator may be mounted on the negative electrode. The positive electrode, on which a lithium ion conductive solid electrolyte membrane is mounted, may be mounted on other side of the case, opposite to the negative electrode. Next, a porous current collector may be disposed on the positive electrode, and a pressing member, e.g., a pressure applicator that allows air to reach the positive electrode may apply pressure to fix the cell, thereby completing the manufacture of the lithium air battery.

Upon the manufacture of the battery, a liquid electrolyte including lithium salt may be injected into a separator mounted on the negative electrode. For example, the separator may be impregnated with 1.0M of LiTFSI propylene carbonate electrolyte.

The case may be divided into upper and lower parts that contact the negative electrode and the air electrode, respectively. An insulating resin may be disposed between the upper and lower parts to electrically insulate the air electrode and the negative electrode from each other.

The lithium air battery may be either a lithium primary battery or a lithium secondary battery. The lithium air battery may be in various shapes, and in some embodiments, may have a coin, button, sheet, stack, cylinder, plane, or horn shape. The lithium air battery may be used as a large-scale battery for electric vehicles.

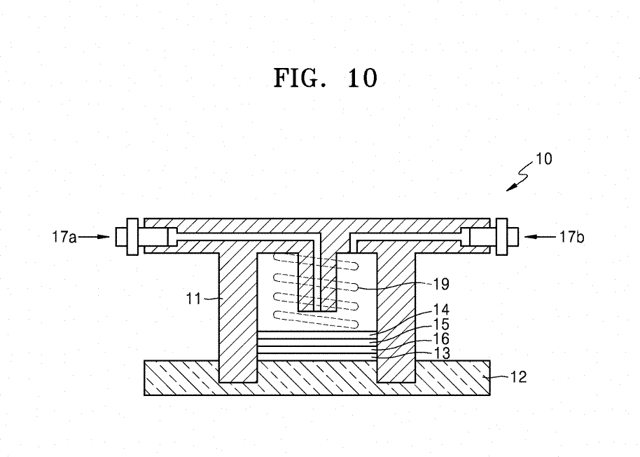

FIG. 10 is a schematic view illustrating an embodiment of a structure of a lithium air battery 10. The lithium air battery 10 includes a positive electrode 15 using oxygen as an active material and being adjacent to a first current collector 14; a negative electrode 13 including lithium and being adjacent to a second current collector 12; and a separator 16 between the positive electrode 15 and the negative electrode 13. A lithium ion conductive solid electrolyte membrane (not shown) may be additionally disposed on one surface of the positive electrode 15 opposite to the separator 16. The first current collector 14, which is porous, may serve as a gas diffusion layer. Also, a pressing member 19 that allows air to reach the positive electrode 15 may be on the first current collector 14. A case 11 formed of an insulating resin between the positive electrode 15 and the negative electrode 13 may electrically insulate the positive electrode 15 and the negative electrode 13 from each other. Air may be supplied through an air inlet 17a and be discharged through an air outlet 17b.

The lithium air battery may be accommodated in a stainless steel reactor.

The term “air” as used herein is not limited to atmospheric air, and may refer to a combination of gases including oxygen, or pure oxygen gas.

This broad definition of “air” also applies to other terms including “air battery” and “air electrode”.

According to an example embodiment, a method of preparing a positive electrode may include preparing an electrolyte-philic organic compound including an imide-based functional group; and bringing the electrolyte-philic organic compound into contact with a carbonaceous core and performing heat treatment at a temperature in a range of from about 100° C. to about 250° C. to prepare a carbonaceous core on which a coating layer of the electrolyte-philic organic compound may be coated.

In the method, the imide-based functional group may be a functional group including an imide group (—CO—NR—CO—). The imide-based functional group may be polar, and has a solubility parameter (δ) of about 23, which is similar with that of an electrolyte, and thus may be easily mixed with the electrolyte. For example, the imide-based functional group may be a substituted or unsubstituted maleimide group, a substituted or unsubstituted succinimide group, a substituted or unsubstituted phthalimide group, or a substituted or unsubstituted glutarimide group, but embodiments are not limited thereto. Any suitable imide-based functional group, which may effectively impregnate a carbonaceous core surface in an electrolyte, may be used as long as the imide-based functional group is electrochemically stable within a driving voltage range of a lithium air battery.

In the method, the carbonaceous core may include carbon nanoparticles, CNTs, carbon nanofibers, carbon nanosheets, carbon nanorods, carbon nanobelts, or a combination thereof.

The heat treatment in the method may be performed at a temperature in a range of from about 100° C. to about 250° C. For example, heat treatment may be performed at a temperature in a range of from about 150° C. to about 200° C. For example, heat treatment may be performed at a temperature in a range of from about 170° C. to about 190° C. In the above heat treatment temperature range, a coating layer of an electrolyte-philic organic compound having a uniform thickness may be formed on the carbonaceous core.

The heat treatment in the method may be performed for about 10 hours to about 40 hours. For example, the heat treatment may be performed for about 20 hours to about 30 hours. For example, the heat treatment may be performed for about 22 hours to about 26 hours. In the above heat treatment time range, a coating layer of an electrolyte-philic organic compound having a uniform thickness may be formed on the carbonaceous core.

The heat treatment atmosphere may be an atmospheric atmosphere or an inert gas atmosphere, such as N₂, Ar, He, or the like, not containing oxygen.

For example, the positive electrode may be manufactured as follows.

A carbonaceous core, which includes the coating layer of the electrolyte-philic organic compound, may be mixed together with a lithium salt and an electrolyte, and then a suitable solvent may optionally be added thereto. Then, the mixture may be heated to prepare a positive electrode slurry, which may then be coated on a surface of a current collector and dried. Optionally, the positive electrode slurry may be compression molded on the current collector to improve the density of the electrode. The current collector may be a gas diffusion layer. In some embodiments, the positive electrode slurry may be applied on a surface of a separator or a solid electrolyte membrane and dried. In some embodiments, the positive electrode slurry may be compression molded on a separator or a solid electrolyte membrane to improve the electrode density.

The lithium salt and the electrolyte used in the positive electrode slurry are the same as described above in relation to the positive electrode.

The positive electrode slurry may optionally include a binder. The binder may include a thermoplastic resin or a thermosetting resin. Non-limiting examples of the binder include polyethylene, polypropylene, polytetrafluoro ethylene (“PTFE”), polyvinylidene fluoride (“PVdF”), styrene-butadiene rubber, tetrafluoroethylene-perfluoro alkyl vinyl ether copolymer, fluorovinylidene-hexafluoropropylene copolymer, fluorovinylidene-chlorotrifluoroethylene copolymer, ethylene-tetrafluoroethylene copolymer, polychlorotrifluoroethylene, fluorovinylidene-pentafluoro propylene copolymer, propylene-tetrafluoroethylene copolymer, ethylene-chlorotrifluoroethylene copolymer, fluorovinylidene-hexafluoropropylene-tetrafluoroethylene copolymer, fluorovinylidene-perfluoromethyl vinyl ether-tetrafluoro ethylene copolymer, and ethylene-acrylic acid copolymer, which may be used alone or in combination. Any suitable binder available in the art may be used.

The separator is not limited as long as it may withstand the use range of the lithium air battery. Examples of the separator include a polymeric nonwoven fabric such as a nonwoven fabric of a polypropylene material or a nonwoven fabric of a polyphenylene sulfide material, and a porous film of an olefin resin such as polyethylene or polypropylene. It is also possible to use two or more thereof in combination.

The current collector may utilize a porous material such as a net-like or mesh shape in order to accelerate the diffusion of oxygen. A porous metal plate such as stainless steel, nickel, or aluminum may be used, but not necessarily limited thereto. Any suitable current collector available in the art may be used. The current collector may be coated with an oxidation-resistant metal or alloy coating to prevent oxidation.

The positive electrode slurry may optionally include an oxygen oxidation/reduction catalyst and electrically conductive material. In addition, the positive electrode slurry may optionally include a lithium oxide.

The electrically conductive material may be used without restriction as long as it has porosity and electrical conductivity. For example, a porous carbonaceous material may be used as an electrically conductive material. Examples of the carbonaceous material include carbon blacks, graphites, graphenes, activated carbons, carbon fibers, and the like. In addition, a metallic electrically conductive material such as metallic fibers or metallic mesh may be used. In addition, metallic powder such as copper, silver, nickel, aluminum may also be included. An organic electrically conductive material such as polyphenylene derivative may also be used. The electrically conductive materials may be used alone or in combination.

Hereinafter example embodiments will be described in detail with reference to Examples and Comparative Examples. These examples are provided for illustrative purposes only and are not intended to limit the scope of the inventive concept.

### EXAMPLES

### Preparation of Organic Compound Including Imide-Based Functional Group

### Preparation Example 1: Preparation of Organic Compound Including Imide Group

4.2 grams (g) of maleic anhydride (available from Sigma-Aldrich Co., Ltd.) and 7.7 g of 3,5-bis(trifluoromethyl)aniline were added to 60 milliliters (mL) of a mixture solution of dimethyl sulfoxide (“DMSO”) and p-dichlorobenzene (“DCB”) at a volumetric ratio of 1:1. The mixture was allowed to undergo reaction for 1 hour, followed by filtration and drying. Thus, Compound 1-1 was obtained.

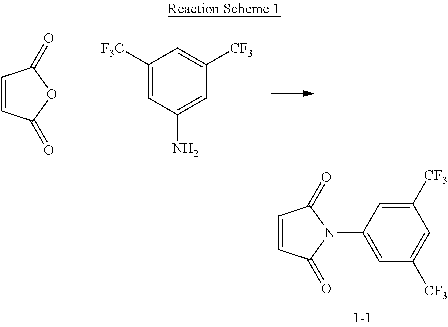 [SMILES: O=C1C=CC(=O)O1 ; Nc1cc(C(F)(F)F)cc(C(F)(F)F)c1 ; O=C1C=CC(=O)N1c1cc(C(F)(F)F)cc(C(F)(F)F)c1]

### Preparation Example 2: Preparation of Organic Compound Including Imide Group

Compound 1-2 was obtained in substantially the same manner as in Preparation Example 1 except that 3,4,5-tris(trifluoromethyl)aniline was used instead of 3,5-bis(trifluoromethyl)aniline.

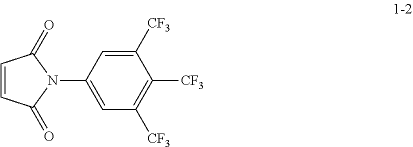 [SMILES: O=C1C=CC(=O)N1c1cc(C(F)(F)F)c(C(F)(F)F)c(C(F)(F)F)c1]

### Preparation Example 3: Preparation of Organic Compound Including Imide Group

Compound 1-3 was obtained in substantially the same manner as in Preparation Example 1 except that aniline was used instead of 3,5-bis(trifluoromethyl)aniline.

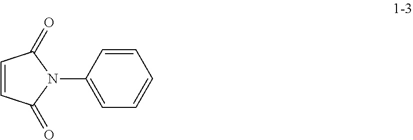 [SMILES: O=C1C=CC(=O)N1c1ccccc1]

### Preparation Example 4: Preparation of Organic Compound Including Imide Group

Compound 1-4 was obtained in substantially the same manner as in Preparation Example 1 except that 3,5-bis(tribromomethyl)aniline was used instead of 3,5-bis(trifluoromethyl)aniline.

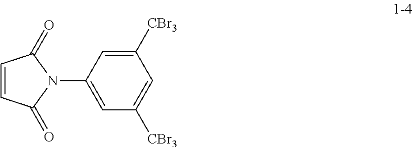

### Preparation Example 5: Preparation of Organic Compound Including Imide Group

Compound 1-5 was obtained in substantially the same manner as in Preparation Example 1 except that 3,5-bis(trifluoromethyl)cyclohexylamine was used instead of 3,5-bis(trifluoromethyl)aniline.

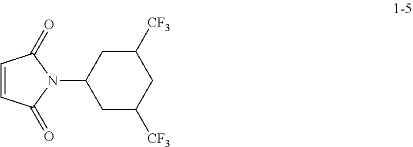 [SMILES: O=C1C=CC(=O)N1C1CC(C(F)(F)F)CC(C(F)(F)F)C1]

### Preparation Example 6: Preparation of Organic Compound Including Imide Group

Compound 1-6 was obtained in substantially the same manner as in Preparation Example 1 except that cyclohexylamine was used instead of 3,5-bis(trifluoromethyl)aniline.

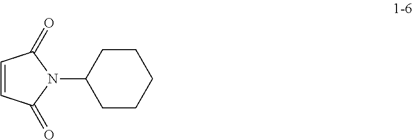 [SMILES: O=C1C=CC(=O)N1C1CCCCC1]

### Preparation Example 7: Preparation of Organic Compound Including Imide Group

Compound 1-7 was obtained in substantially the same manner as in Preparation Example 1 except that ammonia (NH₃) was used instead of 3,5-bis(trifluoromethyl)aniline.

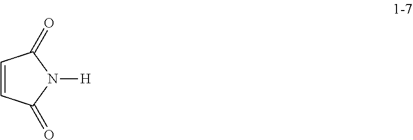

### Preparation Example 8: Preparation of Organic Compound Including Imide Group

Compound 1-8 was obtained in substantially the same manner as in Preparation Example 1 except that methylamine was used instead of 3,5-bis(trifluoromethyl)aniline.

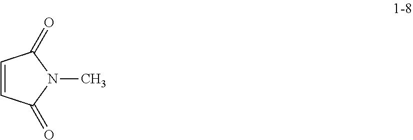

### Preparation Example 9: Preparation of Organic Compound Including Imide Group

Compound 1-9 was obtained in substantially the same manner as in Preparation Example 1 except that 2,2,2-trifluoro-1,1-bis(trifluorometyl)ethylamine was used instead of 3,5-bis(trifluoromethyl)aniline.

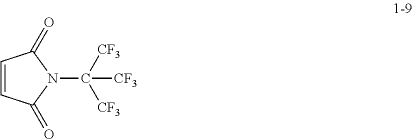 [SMILES: O=C1C=CC(=O)N1C(C(F)(F)F)(C(F)(F)F)C(F)(F)F]

Preparation of Carbonaceous Core on which Coating Layer of Organic Compound Including Imide Group is Formed

### Preparation Example 10: Preparation of Carbonaceous Core on which Coating Layer of Organic Compound Including Imide Group is Formed

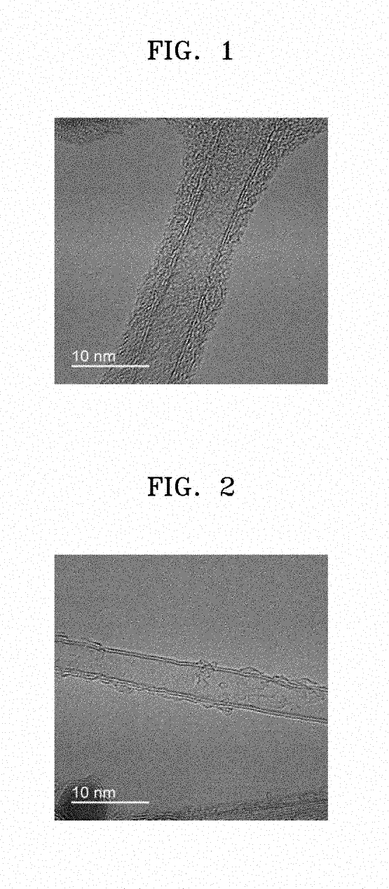

0.1 g of 3×4 cm² CNT (CM250 available from Hanhwa Chemical, Korea) and 0.01 g of Compound 1-1 prepared in Preparation Example 1 were added to 60 mL of a mixture solution of DMSO and p-DCB at a volumetric ratio of 1:1. The mixture was then prepared by stirring. The mixture was heated at a temperature of 180° C. for 24 hours to obtain CNT on which a coating layer of Compound 1-1 is formed. A transmission electron microscope (“TEM”) image of the prepared CNT is shown in FIG. 1.

### Preparation Examples 11 to 18: Preparation of Carbonaceous Core on which Coating Layer of Organic Compound Including Imide Group is Formed

CNTs, on which coating layers of Compounds 1-2 to 1-9 are formed, were obtained in substantially the same manner as in Preparation Example 10 except that Compounds 1-2 to 1-9 were used instead of Compound 1-1, respectively.

### Comparative Preparation Example 1: Carbonaceous Material

3×4 cm² CNT (CM250 available from Hanhwa Chemical, Korea) were used without a coating layer formed thereon. A TEM image of the CNT is shown in FIG. 2.

### Preparation of Positive Electrode/Solid Electrolyte Membrane

### Example 1: Preparation of Positive Electrode/Solid Electrolyte Membrane Structure

1-ethyl-3-methyl amidazolium bis(trifluoromethyl sulfonyl)imide (“EMI-TFSI”) as an ionic liquid was mixed with 0.5M LiTFSI as a lithium salt at a molar ratio of 10:1 to prepare an electrolyte. The electrolyte was mixed with the CNT, on which a coating layer of Compound 1-1 prepared in Preparation Example 10 is formed, at a weight ratio of 2.5:1 to prepare a positive electrode slurry.

The positive electrode slurry was spread on a solid electrolyte membrane (LICGC™ (LATP, Ohara Co., Ltd, thickness: 250 micrometers (μm))). Then, the positive electrode slurry was coated thereon using a roller to prepare a positive electrode/solid electrolyte membrane structure. Here, a loading amount of the positive electrode was 3.0 milligrams per square centimeter (mg/cm²).

### Examples 2 to 9: Preparation of Positive Electrode/Solid Electrolyte Membrane Structure

Positive electrode/solid electrolyte membrane structures were manufactured in substantially the same manner as in Example 1, except that CNTs, on which coating layers of Compounds 1-2 to 1-9 prepared in Preparation Examples 11 to 18 are formed, were used instead of the CNT, on which a coating layer of Compound 1-1 prepared in Preparation Example 10 is formed, respectively. Here, a loading amount of each positive electrode was 3.0 mg/cm².

### Comparative Example 1: Preparation of Positive Electrode/Solid Electrolyte Membrane Structure

A positive electrode/solid electrolyte membrane structure was manufactured in substantially the same manner as in Example 1, except that CNT without a coating layer was used instead of the CNT, on which a coating layer of Compound 1-1 prepared in Preparation Example 10 is formed. Here, a loading amount of each positive electrode was 3.0 mg/cm².

### Comparative Example 2: Preparation of Positive Electrode/Solid Electrolyte Membrane Structure

A positive electrode/solid electrolyte membrane structure was manufactured in substantially the same manner as in Example 1, except that the electrolyte was mixed with the CNT, on which a coating layer of Compound 1-1 prepared in Preparation Example 10 is formed, at a weight ratio of 10:1 instead of 2.5:1. Here, a loading amount of the positive electrode was 3.0 mg/cm².

### Comparative Example 3: Preparation of Positive Electrode/Solid Electrolyte Membrane Structure

A positive electrode/solid electrolyte membrane structure was manufactured in substantially the same manner as in Example 1, except that CNT without a coating layer of Comparative Example 1 was used, and the electrolyte was mixed with the CNT at a weight ratio of 10:1 instead of 2.5:1. Here, a loading amount of the positive electrode was 3.0 mg/cm².

### Manufacture of Lithium Air Battery

### Example 10: Manufacture of Lithium Air Battery

A stainless steel wire (SUS) mesh was fixed onto a polytetrafluoroethylene case. Then, a φ (thickness) 16 mm lithium metal negative electrode was mounted on the SUS mesh. A PEO film (having a thickness of 150 μm) was disposed as a negative electrode interlayer (not shown) on the lithium metal negative electrode to prevent direct contact between LATP and lithium. The PEO film used herein was prepared as follows.

Polyethylene oxide (having a molecular weight of 600,000) and LiTFSI were added to 100 mL of acetonitrile followed by mixing for 12 hours. A molar ratio of LiTFSI to polyethyleneoxide was 1:18.

The negative electrode interlayer was stacked on the lithium metal thin film negative electrode, and the positive electrode/solid electrolyte membrane structure prepared in Example 1 was disposed on the negative electrode interlayer, thereby completing the manufacture of a cell having a structure shown in FIG. 10. As shown in FIG. 10, a LATP solid electrolyte membrane (having a thickness of 250 μm) as an oxygen barrier was disposed to be in contact with the negative electrode interlayer (not shown).

The other surface of a positive electrode is a gas diffusion layer. On the gas diffusion layer, a φ (thickness) 15 mm carbon paper (having a thickness of 250 μm, 35-DA available from SGL) was stacked. A SUS mesh was stacked as a current collector on the carbon paper, thereby completing the manufacture of a lithium air battery shown in FIG. 10. Finally, the polytetrafluoroethylene case was sealed, and the lithium air battery was fixed by pressing with a pressing member.

### Examples 11 to 18: Manufacture of Lithium Air Battery

Lithium air batteries were manufactured in substantially the same manner as in Example 10, except that the positive electrode/solid electrolyte membrane structures manufactured in Examples 2 to 9 were used instead of the positive electrode/solid electrolyte membrane structure manufactured in Example 1, respectively.

### Comparative Examples 4 to 6: Manufacture of Lithium Air Battery

Lithium air batteries were manufactured in substantially the same manner as in Example 10, except that the positive electrode/solid electrolyte membrane structures manufactured in Comparative Examples 1 to 3 were used instead of the positive electrode/solid electrolyte membrane structure manufactured in Example 1, respectively.

### Evaluation Example 1: Thermogravimetric Analysis (“TGA”) Evaluation

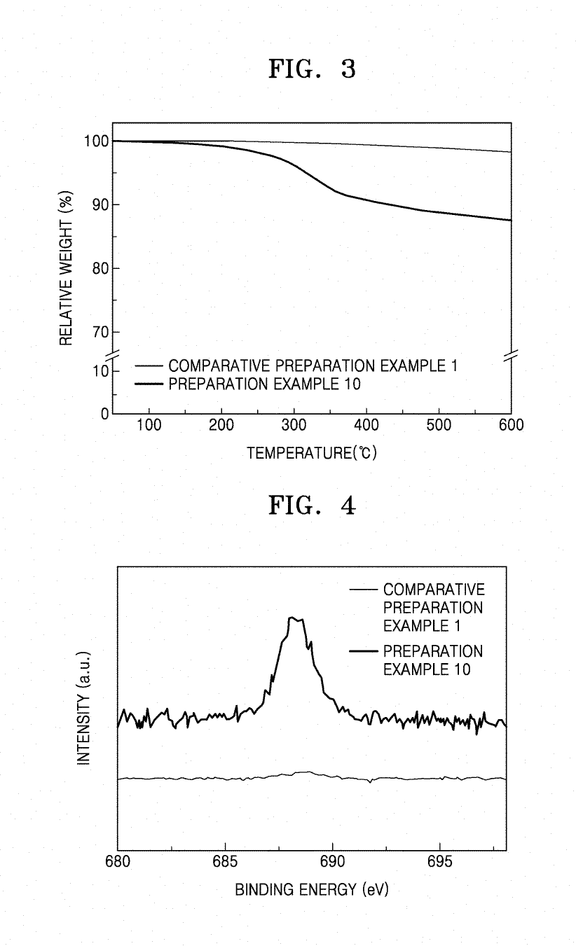

The CNT prepared in Preparation Example 10, on which an organic compound including an imide group is coated, and the pure CNT without a coating layer prepared in Comparative Preparation Example 1 underwent a thermogravimetric analysis (“TGA”) experiment under a nitrogen atmosphere with a heating rate of 5° C./min. The results are shown in FIG. 3. TA SDT 2010 TGA/DSC1 (Simultaneous TGA-DSC, available from METTLER TOLEDO) was performed in a temperature range of about 0° C. to about 600° C.

As shown in FIG. 3, a weight loss of the pure CNT without a coating layer prepared in Comparative Preparation Example 1 did not occur until a temperature of 600° C. However, a weight loss of the CNT prepared in Preparation Example 10 started from a temperature of 200° C., and at a temperature of 350° C., the weight decreased by about 10% as compared with the initial weight. Accordingly, it is found that in the CNT prepared in Preparation Example 10 is coated with about 10% of an organic compound including an imide group.

### Evaluation Example 2: X-Ray Photoelectron Spectroscopy (“XPS”) Evaluation

The CNT prepared in Preparation Example 10, on which an organic compound including an imide group is coated, and the pure CNT without a coating layer prepared in Comparative Preparation Example 1 underwent an X-ray photoelectron spectroscopy (“XPS”). The results thereof are shown in FIG. 4.

The elements of the CNT prepared in Preparation Example 10 and the pure CNT prepared in Comparative Preparation Example 1, and the amounts thereof are shown in Table 1.

TABLE 1

| | | Comparative |
|---|---|---|
| | Preparation | Preparation |
| Element | Example 10 | Example 1 |
| Fluorine (F) | 2.48 weight % | — |
| Oxygen (O) | 2.71 weight % | 2.70 weight % |
| Carbon (C) | 94.8 weight % | 97.3 weight % |

As shown in FIG. 4, the pure CNT prepared in Comparative Preparation Example 1 did not show any peak at about 689 electron volts (eV). However, the CNT prepared in Preparation Example 10 showed a peak corresponding to F is at about 689 eV.

As shown in Table 1, the CNT prepared in Preparation Example 10 was found to contain 2.48 weight % of fluorine (F).

Accordingly, it is found that in the CNT prepared in Preparation Example 10 is coated with an organic compound including an imide group including F.

### Evaluation Example 3: Electrolyte Contact Angle Evaluation

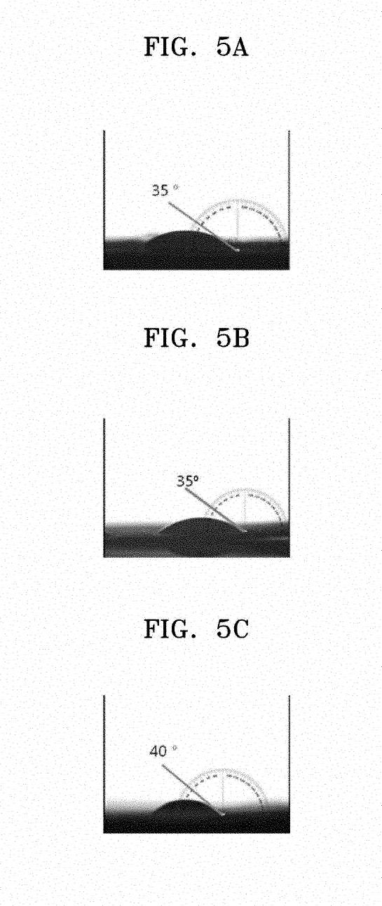

The contact angle with an electrolyte of each of the CNTs prepared in Preparation Examples 10 and 16 and the pure CNT prepared in Comparative Preparation Example 1. As a measurement method, a drop of EMI-TFSI, i.e., an ionic liquid, as an electrolyte was poured on each of the CNTs prepared in Preparation Examples 10 and 16 and Comparative Preparation Example 1 to measure the contact angle. The results thereof are shown in FIGS. 5A, 5B, and 5C.

As shown in FIG. 5C, the pure CNT of Comparative Preparation Example 1 was found to have an electrolyte contact angle of 40°. However, each of the CNT of Preparation Example 10 (FIG. 5A) and the CNT of Preparation Example 16 (FIG. 5B) was found to have an electrolyte contact angle of 35°. In an embodiment, the carbonaceous core has a contact angle with the electrolyte-philic organic compound of less than 40°, for example, of 35°.

Accordingly, it was found that the carbonaceous core coated with an organic compound including an imide group has a significantly improved electrolyte-retaining ability, as compared with a pure carbonaceous material without a coating layer.

### Evaluation Example 4: Charge/Discharge Capacity Characteristics Evaluation

### 4-1. Evaluation of Charge/Discharge Characteristics Depending on Presence of Coating Layer of an Organic Compound Including Imide Group

At a temperature of 25° C. and at atmospheric pressure (1 atm), the lithium air batteries manufactured in Example 10 and 16 and Comparative Example 4 were discharged with a constant current of 0.24 milliampere per square centimeter (mA/cm²) until the voltage reached 2.0 V (vs. Li). Then, with the same current, the lithium air batteries were charged until the voltage reached 4.3 V to perform a charge/discharge test.

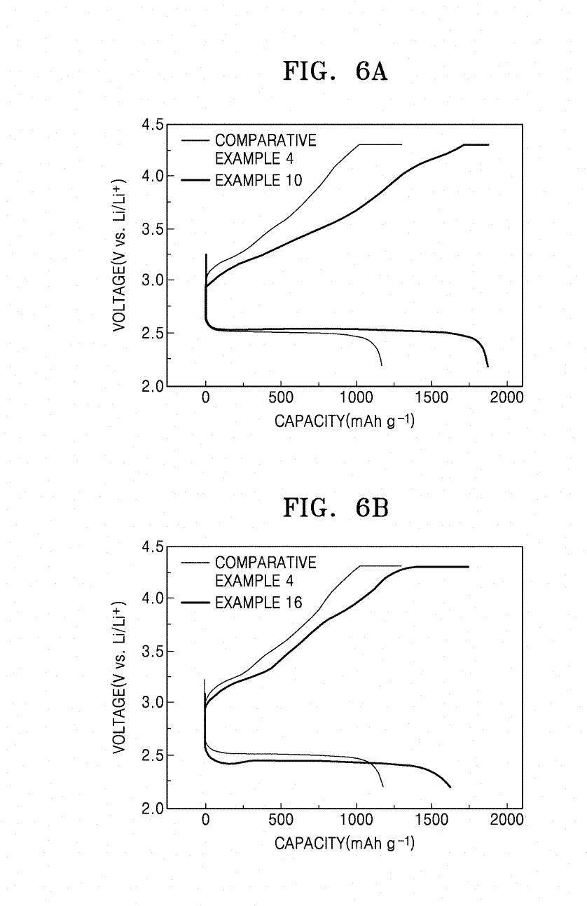

The results of charge/discharge test at the 1^{st} cycle are shown in FIGS. 6A and 6B and Table 2.

TABLE 2

| | Discharge capacity at the 1^{st} cycle |
|---|---|
| | [milliampere-hours per gram (mAh/g)] |
| Example 10 | 1,800 |
| Example 16 | 1,600 |
| Comparative | 1,100 |
| Example 4 | |

As shown in FIGS. 6A and 6B and Table 2, the lithium air batteries of Example 10 (FIG. 6A) and Example 16 (FIG. 6B) employing a carbonaceous core coated with an organic compound including an imide group as a positive electrode were found to have significantly improved charge/discharge capacity, as compared with the lithium air battery of Comparative Example 4 employing a pure carbonaceous material as a positive electrode.

Accordingly, it was found that a lithium air battery employing a carbonaceous core coated with an organic compound including an imide group has improved affinity to a positive electrode and thus has improved charge/discharge capacity, as compared with a lithium air battery employing a pure carbonaceous material as a positive electrode without a coating layer.

### 4-2. Evaluation of Charge/Discharge Characteristics Depending on Amount of Electrolyte

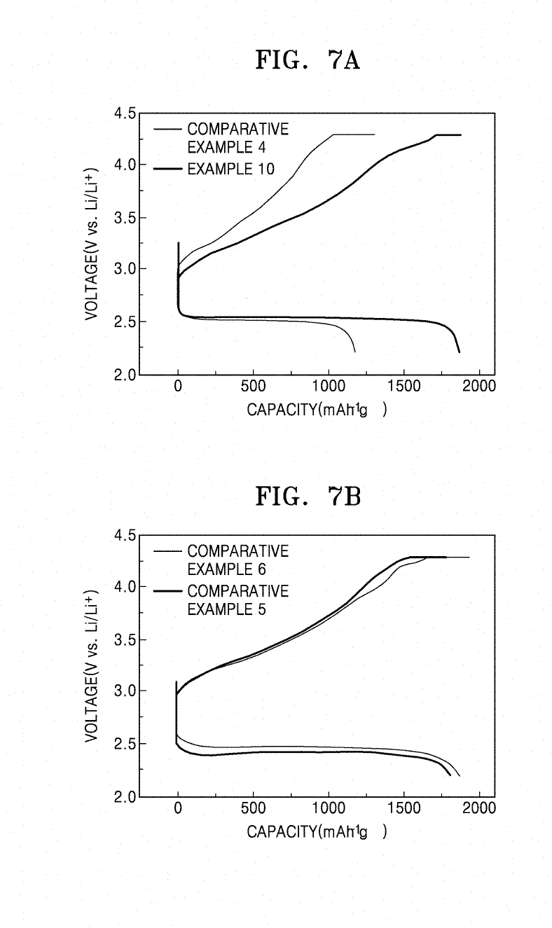

The charge/discharge test performed in Section 4-1 was performed on the lithium air batteries manufactured in Example 10 and Comparative Examples 4, 5, and 6. The results of charge/discharge test at the 1^{st} cycle are shown in FIGS. 7A and 7B.

As shown in FIG. 7A, the lithium air battery including as a positive electrode the CNT coated with an organic compound including an imide group of Example 10, in which a weight ratio of the electrolyte to the CNT is 2.5:1 (i.e., small amount of electrolyte condition), was found to have significantly improved charge/discharge capacity, as compared with the lithium air battery including as a positive electrode the pure CNT without a coating layer of Comparative Example 4.

As shown in FIG. 7B, when a weight ratio of the electrolyte to the CNT is 10:1 (i.e., excessive amount of electrolyte condition), the lithium air battery including as a positive electrode the CNT coated with an organic compound including an imide group of Comparative Example 5 and the lithium air battery including as a positive electrode the pure CNT without a coating layer of Comparative Example 6 had no difference in terms of charge/discharge capacity from each other.

Accordingly, when an amount of an electrolyte is excessive, sufficient charge/discharge capacity may be exhibited even with a pure carbonaceous material without a coating layer as a positive electrode; however, when an amount of the electrolyte is relatively low, a lithium air battery employing as a positive electrode as a carbonaceous core coated with an organic compound including an imide group has improved electrolyte affinity, as compared with a lithium air battery including as a positive electrode a pure carbonaceous material without a coating layer. Thus, the lithium air battery employing as a positive electrode as a carbonaceous core coated with an organic compound including an imide group was found to have further improved charge/discharge capacity.

### Evaluation Example 5: Charge/Discharge Cycle Characteristics Evaluation

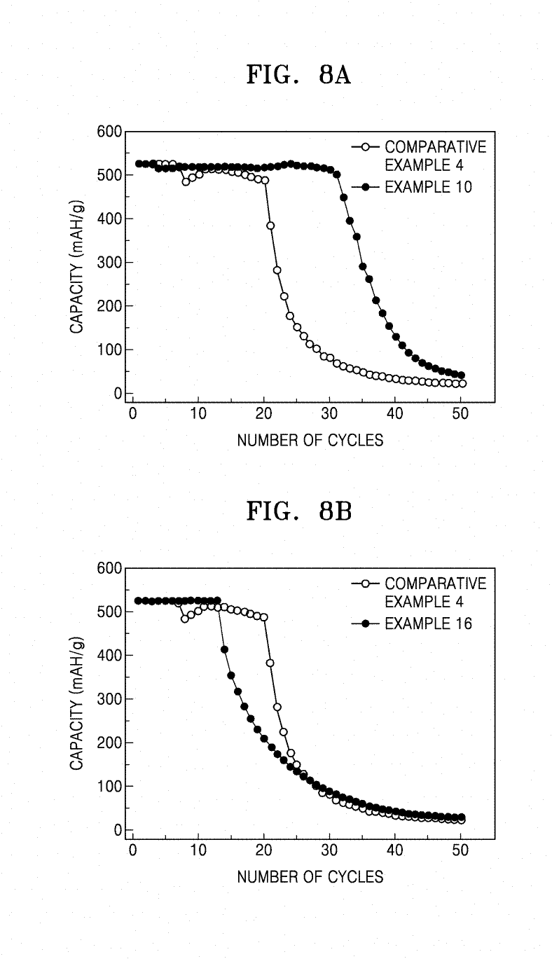

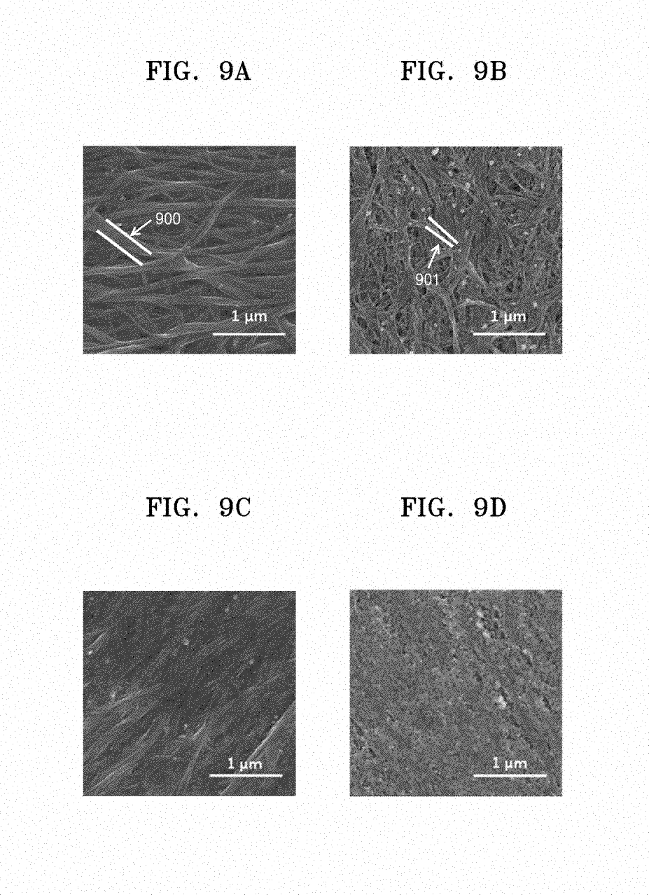

At a temperature of 25° C. and at 1 atm, the lithium air batteries manufactured in Example 10 and 16 and Comparative Example 4 were discharged with a constant current of 0.24 mA/cm² until the voltage reached 2.0 V (vs. Li). Then, with the same current, the lithium air batteries were charged until the voltage reached 4.3 V to perform a charge/discharge cycle test. Upon discharge, the number of cycles in which a discharge capacity of 500 mAh/g or larger at 2.0 V (vs. Li) was maintained was measured. The results thereof are shown in FIGS. 8A and 8B and Table 3. After performing 27 charge/discharge cycles for each of the lithium air batteries of Example 10 and Comparative Example 4, the batteries were dissembled, and the CNTs in the positive electrode were observed using a scanning electron microscope (SEM). The images thereof are shown in FIGS. 9A, 9B, 9C, and 9D. In FIG. 9A, reference number 900 refers to CNT and Li₂O₂, and in FIG. 9B, reference numeral 901 refers to CNT.

TABLE 3

| | The number of cycles in which a discharge capacity of |
|---|---|
| | 500 mAh/g or larger at 2.0 V (vs. Li) was maintained |
| Example 10 | 32 |
| Example 16 | 14 |
| Comparative | 22 |
| Example 4 | |

As shown in FIG. 8A, the lithium air battery of Example 10 employing a carbonaceous core coated with an organic compound including an imide group as a positive electrode was found to have significantly improved charge/discharge cycle characteristics, as compared with the lithium air battery of Comparative Example 4 employing a pure carbonaceous material as a positive electrode.

As shown in FIG. 8B, the lithium air battery of Example 16 employing a carbonaceous core coated with an organic compound including an imide group as a positive electrode was found to have deteriorated charge/discharge cycle characteristics, as compared with the lithium air battery of Comparative Example 4.

This result shows that in the case of the lithium air battery of Example 16, upon charging and discharging, irreversible materials (H₂O, CO, NO, etc.) may be generated due to a side reaction between the organic compound including an imide group (Compound 1-7) included in the coating layer and superoxides (O²⁻), which resulted in deterioration of charge/discharge cycle stability.

However, in the case of the lithium air battery of Example 10, since the organic compound including an imide group (Compound 1-1) included in the coating layer includes a bulky functional group, a side reaction between the organic compound including an imide group included in the coating layer and superoxides (O²⁻) may be prevented, which resulted in further improvement of charge/discharge cycle characteristics.

As apparent from the foregoing description, when a lithium air battery employs a positive electrode including a carbonaceous material with a modified surface, lithium air battery may have improved discharge capacity and lifespan characteristics.

It should be understood that embodiments described herein should be considered in a descriptive sense only and not for purposes of limitation. Descriptions of features or aspects within each embodiment should be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A positive electrode comprising:
a carbonaceous core;
a coating layer comprising an electrolyte-philic organic compound on the carbonaceous core;
a lithium salt; and
an electrolyte,
wherein the electrolyte-philic organic compound comprises an imide functional group.

2. The positive electrode of claim 1, wherein the imide functional group comprises a substituted or unsubstituted maleimide group, a substituted or unsubstituted succinimide group, a substituted or unsubstituted phthalimide group, or a substituted or unsubstituted glutarimide group,
wherein at least one substituent of the substituted maleimide group, the substituted succinimide group, the substituted phthalimide group, and the substituted glutarimide group comprises
deuterium, a substituted or unsubstituted C₁-C₃₀ alkyl group, a substituted or unsubstituted C₃-C₃₀ cycloalkyl group, or a substituted or unsubstituted C₆-C₃₀ aryl group, wherein at least one substituent of the substituted C₁-C₃₀ alkyl group, the substituted C₃-C₃₀ cycloalkyl group, and the substituted C₆-C₃₀ aryl group comprises
deuterium, —F, —Cl, —Br, —I, a hydroxyl group, a C₁-C₃₀ alkyl group, a C₃-C₃₀ cycloalkyl group, or a C₆-C₃₀ aryl group, or
a C₁-C₃₀ alkyl group, a C₃-C₃₀ cycloalkyl group, or a C₆-C₃₀ aryl group, each substituted with deuterium, —F, —Cl, —Br, —I, a hydroxyl group, a C₁-C₆₀ alkyl group, a C₃-C₃₀ cycloalkyl group, a C₆-C₃₀ aryl group, or a combination thereof, or
a combination thereof.

3. The positive electrode of claim 1, wherein the electrolyte-philic organic compound comprising an imide functional group is represented by Formula 1: 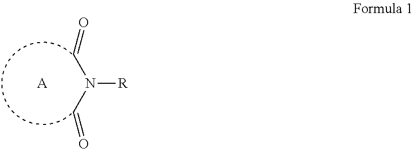
wherein, in Formula 1,
ring A is a C₂-C₃₀ heterocyclic group comprising an imide group,
R is hydrogen, deuterium, a substituted or unsubstituted C₁-C₃₀ alkyl group, a substituted or unsubstituted C₃-C₃₀ cycloalkyl group, or a substituted or unsubstituted C₆-C₃₀ aryl group,
wherein at least one substituent of the substituted C₁-C₃₀ alkyl group, the substituted C₃-C₃₀ cycloalkyl group, and the substituted C₆-C₃₀ aryl group comprises
deuterium, —F, —Cl, —Br, —I, a hydroxyl group, a C₁-C₃₀ alkyl group, a C₃-C₃₀ cycloalkyl group, or a C₆-C₃₀ aryl group, or
a C₁-C₃₀ alkyl group, a C₃-C₃₀ cycloalkyl group, and a C₆-C₃₀ aryl group, each substituted with deuterium, —F, —Cl, —Br, —I, a hydroxyl group, a C₁-C₆₀ alkyl group, a C₃-C₃₀ cycloalkyl group, or a C₆-C₃₀ aryl group,
or a combination thereof.

4. The positive electrode of claim 3, wherein ring A is a C₂-C₃₀ heterocycloalkane ring, a C₂-C₃₀ heterocycloalkene ring, a C₂-C₃₀ heterocycloalkyne ring, or a C₂-C₃₀ heteroaryl ring, each comprising an imide group.

5. The positive electrode of claim 3, wherein R is a C₁-C₃₀ alkyl group, a C₃-C₃₀ cycloalkyl group, or a C₆-C₃₀ aryl group, each substituted with at least one —CF₃ group.

6. The positive electrode of claim 1, wherein the electrolyte-philic organic compound comprising an imide functional group comprises a multiple bond or a conjugated bond.

7. The positive electrode of claim 3, wherein the electrolyte-philic organic compound represented by Formula 1 is Compound 1-1 to 1-9, or combination thereof:

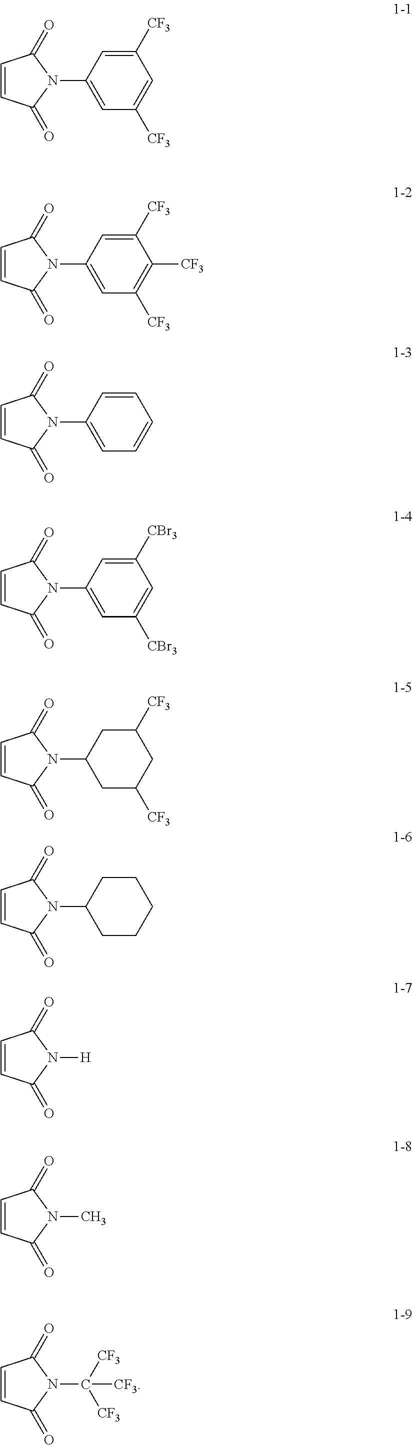

8. The positive electrode of claim 1, wherein a thickness of the coating layer is in a range of about 1 nanometer to about 20 nanometers.

9. The positive electrode of claim 1, wherein a content of the coating layer is in a range of about 5 percent by weight to about 20 weight percent, based on a total weight of the carbonaceous core.

10. The positive electrode of claim 1, wherein the coating layer is continuous or in an island form on the carbonaceous core.

11. The positive electrode of claim 1, wherein the core has a spherical shape, a rod shape, a planar shape, a tube shape, or a combination thereof.

12. The positive electrode of claim 1, wherein the carbonaceous core comprises carbon black, Ketjen black, acetylene black, natural graphite, artificial graphite, expanded graphite, graphene, graphene oxide, fullerene soot, mesophase carbon microbeads, carbon nanotubes, carbon nanofibers, carbon nanobelts, soft carbon, hard carbon, pitch carbide, mesophase pitch carbide, sintered coke, or a combination thereof.

13. The positive electrode of claim 1, wherein the electrolyte comprises an ion-conductive polymer, an ionic liquid, or an organic liquid electrolyte.

14. The positive electrode of claim 13, wherein the electrolyte comprises the ionic liquid and the ionic liquid comprises 1-ethyl-3-methylimidazolium bis-(trifluoromethylsulfonyl)imide, diethylmethylammonium trifluoromethanesulfonate, dimethylpropylammonium trifluoromethanesulfonate, diethylmethylammonium trifluoromethanesulfonylimide, methylpropylpiperidinium trifluoromethanesulfonylimide, or a combination thereof.

15. The positive electrode of claim 1, wherein a weight ratio of a weight of the electrolyte to a total weight of the carbonaceous core and the coating layer of the electrolyte-philic organic compound is in a range of about 1:1 to about 5:1.

16. The positive electrode of claim 1, wherein the lithium salt comprises lithium bis(trifluoromethanesulfonyl)imide, LiPF₆, LiBF₄, LiAsF₆, LiClO₄, LiNO₃, or a combination thereof.

17. A lithium air battery comprising:
the positive electrode according to claim 1;
a negative electrode capable of intercalating and deintercalating lithium ions; and
a separator between the positive electrode and the negative electrode.

18. The lithium air battery of claim 17, wherein upon charging and discharging of the lithium air battery, the number of cycles in which a discharge capacity is 500 milliampere-hours per gram or greater is 20 or more when charging to a voltage of 2.0 volts versus lithium metal.

19. A method of preparing a positive electrode, the method comprising:
providing an electrolyte-philic organic compound comprising an imide functional group;
contacting the electrolyte-philic organic compound and a carbonaceous core to form a mixture; and
heat-treating the mixture at a temperature in a range of from about 100° C. to about 250° C. to prepare the positive electrode, the positive electrode comprising the carbonaceous core and a coating layer comprising the electrolyte-philic organic compound on the carbonaceous core.

20. The method of claim 19, wherein the heat-treating comprises heat-treating for about 10 hours to about 40 hours.
